(19) United States
(12) Patent Application Publication
(10) Pub. No.: US 2006/0064924 A1
(43) Pub. Date: Mar. 30, 2006

(54) Pest control device and method

(76) Inventor: Frank R. Lee, Las Vegas, NV (US)

Correspondence Address: WEISS & MOY PC, 4204 NORTH BROWN AVENUE, SCOTTSDALE, AZ, 85251, US

(21) Appl. No.: 10/939,125

(22) Filed: Sep. 13, 2004

(51) Int. Cl. A01M 1/24; F25D 3/00; A01M 1/20

(52) U.S. Cl. 43/124; 43/132.1; 62/293

(57) ABSTRACT

A pest control device includes a housing having a wall through which at least one thermoelectric module is mounted for cooling ambient air within the housing to a temperature of between about 0 degrees and about 40 degrees Fahrenheit or less, a fan unit within the housing for drawing in and discharging the cooled air through a hose coupled to the housing and in communication with the fan unit for discharging the cold air exteriorly of the housing toward pests and insects for their safe and effective substantial elimination.

### FIELD OF THE INVENTION

This invention relates generally to a pest control device and more particularly to an improved pest control device and method for use thereof to substantially eliminate insects and other pests without the use of harmful chemicals.

### BACKGROUND OF THE INVENTION

Commercial pest control services use a variety of expensive and dangerous pesticides and insecticides that while killing pests and other insects, may also be harmful to people, pets and the environment. These products must be handled by experienced professionals and their application often requires that the treated premises be vacated which causes inconvenience and the interruption of business. Even after their application, these products pose continued harm if product residue remains on surfaces within the premises.

Non-chemical methods have been used in an attempt to eliminate pests and insects. For example, U.S. Pat. No. 4,817,329 to Forbes describes the use of heat. U.S. Pat. No. 5,768,907 to the present inventor describes the use of a pest control system that uses cold air to substantially eliminate pests but the system described requires the use of a substantially heavy, large and bulky device that makes its portability less than ideal. U.S. Pat. No. 6,205,702 describes a system for controlling insects with the use of carbon dioxide.

Accordingly, there has been a need for a novel improved pest control device and method that are substantially safe for people, pets, and the environment while still being effective in substantially controlling and eliminating insects and other pests without using harmful and dangerous products, so that people and pets can be present and people's work may proceed without interruption. There is a further need for a novel pest control device and method that are easy to use and do not require the use of an experienced professional. There is still another need for a novel pest control device and method that are relatively inexpensive and effective in a relatively short period of time. There is another need for a novel pest control device and method that are highly portable and convenient to use. There is yet another need for a novel pest control device and method that are substantially simple to manufacture and use. The present invention fulfills these needs and provides other related advantages.

### SUMMARY OF THE INVENTION

In accordance with this invention, it is an object of this invention to provide an improved pest control device and method that substantially eliminate pests and other insects without the use of harmful and toxic chemicals.

It is a further object of this invention to provide an improved pest control device and method that are relatively easy to use by a non-professional and that are substantially inexpensive and lightweight, thereby making the device highly portable and convenient to use.

It is a further object of this invention to provide an improved pest control device and method that are relatively inexpensive and effective in a relatively short period of time.

It is an additional object of this invention to provide an improved pest control device and method that are substantially simple to manufacture and use.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view of a pest control device embodying the novel features of the invention, illustrating a user holding the device for use thereof;

FIG. 2 is a right side elevational view of the device shown in FIG. 1, the left side being a mirror image thereof;

FIG. 3 is a cross-sectional view of the device, illustrating the interior of the housing;

FIG. 4 is another perspective view of the device, illustrating a side wall cutaway to illustrate the interior of the device;

FIG. 5 is an alternative embodiment of the pest control device, illustrating the fan unit without the battery supported within the interior of the housing; and

FIG. 6 is a perspective view of the alternative embodiment of FIG. 5.

### DETAILED DESCRIPTION OF THE PREFERRED EMBODIMENTS

As shown in the drawings for purposes of illustration, the present invention is concerned with an improved pest control device, generally designated in the accompanying drawings by the reference number 10. The method for using the device to substantially eliminate insects and other pests is also provided. The pest control device 10 comprises, generally, a housing 12 with a thermoelectric module 14 mounted through a wall of the housing for cooling air within the housing, and fan unit 16 within the housing for drawing in the cooled air and discharging the cooled air at insects and other pests through a hose 18 in fluid communication with the fan unit 16 and terminating exteriorly of the housing 12.

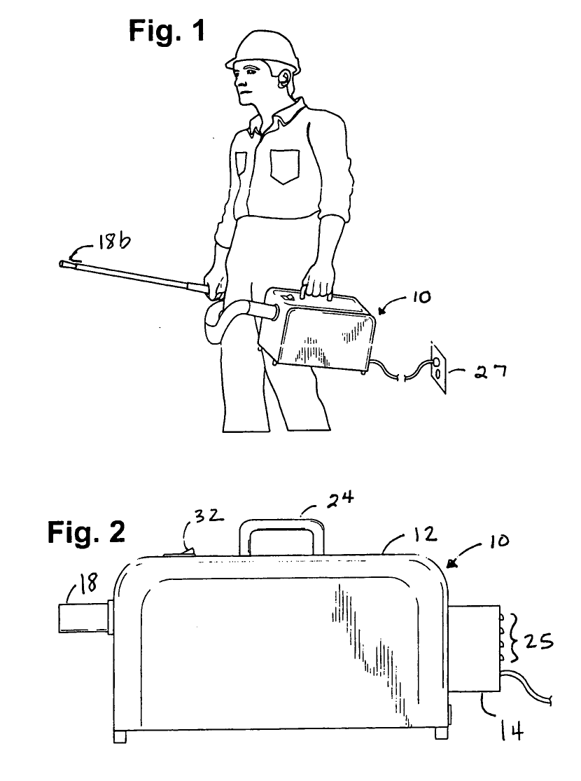

In accordance with the present invention, and as illustrated with respect to preferred embodiments in FIGS. 1-6, the device 10 enables a non-skilled user to inexpensively, easily, effectively and safely substantially eliminate insects and other pests without the use of harmful chemicals.

As shown in FIGS. 1-6, the housing 12 may be generally rectangular and includes a front wall 12a, top and bottom walls 12b and 12c, side walls 12d and a rear wall 12e and a substantially hollow interior 20. The inboard surface of the housing walls 12a-12e may be substantially covered with at least one layer of reflective material 22 such as aluminum or other suitable reflective material for better temperature control within the interior of the housing. The housing 12 may further include a handle 24 for ease in carrying the device.

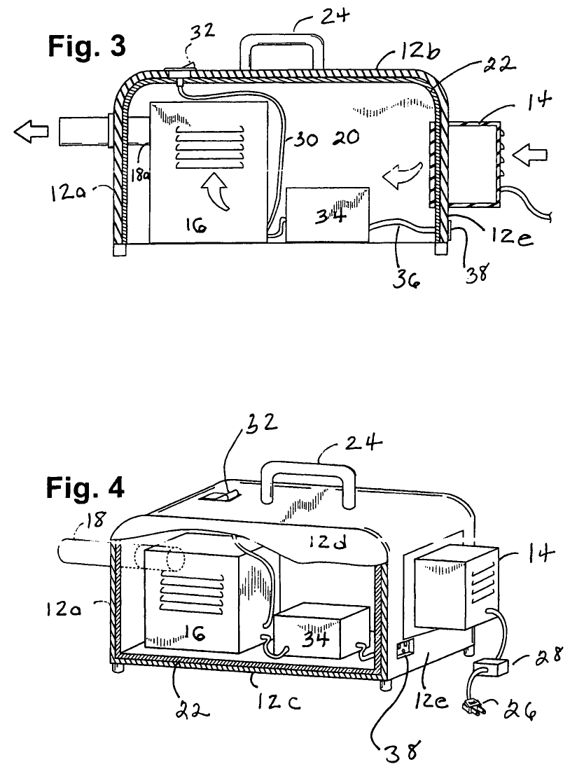

The at least one thermoelectric (TE) module 14 may be mounted through the rear wall 12e of the housing as shown in FIG. 3. The thermoelectric module 14, also known as a Peltier device is a small solid-state device well known in the art to function as a heat pump. As is well known in the art, the thermoelectric module 14 includes a hot/cold switch (not shown). The switch is set to cold in the present invention. The Peltier device cools the ambient air inside the housing. The Peltier device includes a series of vents 25 to dissipate the heat generated during operation of the device. The Peltier device lowers the temperature of the ambient air within the housing 12. It is understood that the TE modules may be stacked to achieve lower temperatures within the interior of the housing as is well known in the art. The air within the housing may be cooled to an effective temperature of less than about 40 degrees Fahrenheit, preferably between about 0 degrees Fahrenheit and 32 degrees Fahrenheit for substantially eliminating most of the insects and other pests. Substantial elimination is enhanced by cooling the air within the housing to about 0 degrees Fahrenheit.

The at least one thermoelectric module 14 may be connected by a power cord and plug 26 to an AC power source 27 through an AC/DC converter 28. The Peltier device may be activated by DC current. In an alternative embodiment of the invention, the at least one thermoelectric module may be operated by one or more batteries (not shown).

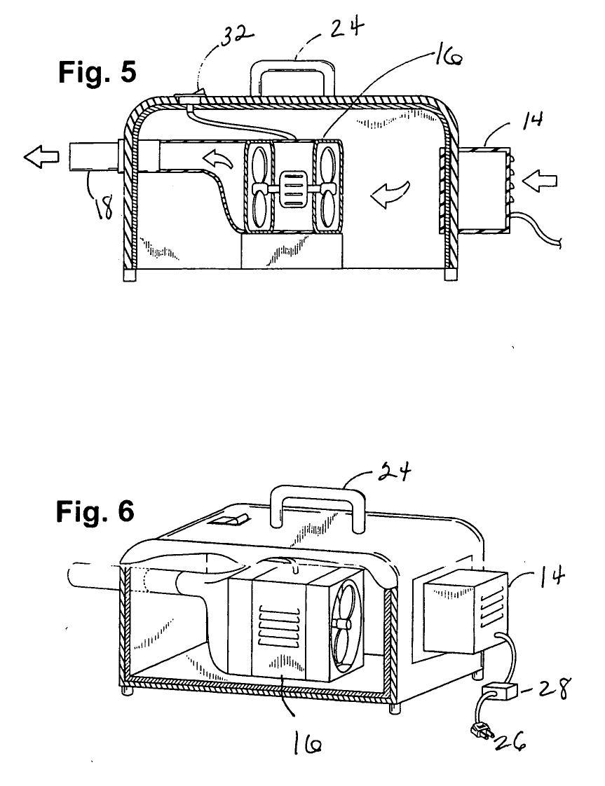

The fan unit 16 in the interior of the housing may be mounted to one of the housing walls, preferably proximate the front wall 12a as shown in FIG. 3. In a preferred embodiment, the fan unit 16 comprises a fan housing carrying a motor and a fan for drawing in air within the housing that has been cooled by the at least one thermoelectric module 14. Electrical power for the fan unit may be conveniently obtained from a suitable power source (not shown) via a fan unit power cord 30, with an appropriate on-off switch 32 mounted on the housing exterior as shown in FIGS. 5-6. The fan unit may also be driven by a battery 34 as illustrated in FIGS. 3 and 4. The battery may be recharged from a power source (not shown) via a power cord 36 and a power receptacle 38 on the housing exterior. The weight of the device may be lowered if no battery is used thus easing its use.

The hose 18 includes a first end 18a in fluid communication with the fan unit 16 within the housing and a second end 18b extending exteriorly of the housing. As shown in FIGS. 3-6, the hose 18 extends from the fan unit 16 within the housing through an aperture (not shown) in the front wall 12a of the housing. The second end 18b may include a nozzle (not shown) for dispersing the cooled air to blanket the insects and other pests. The nozzle preferably has a plurality of apertures (not shown) for wider dispersion.

An improved method for pest control comprises the steps of: providing a housing with at least one thermoelectric module mounted through a wall of the housing for cooling air within the housing; activating the at least one thermoelectric module; activating the fan unit within the housing to draw the cooled air from within the housing; and discharging the cooled air exteriorly of the housing toward insects and other pests, thereby safely and effectively substantially eliminating the insects and other pests. The method further comprises the steps of applying current to each of the at least one thermoelectric module and the fan unit; and activating the at least one thermoelectric module and the fan unit. Further steps of the method comprise directing a hose at the insects and other pests, the hose in communication with the fan unit and extending exteriorly of the housing; discharging the cooled air exteriorly of the housing at the insects and other pests; and cooling the air within the housing to an effective temperature of less than about 40 degrees Fahrenheit. The method further includes the step of cooling the air within the housing to an effective temperature of between about 0 degrees Fahrenheit and about 32 degrees Fahrenheit and more preferably cooling the air within the housing to an effective temperature of about 0 degrees Fahrenheit. The method further includes the step of providing a housing having an inboard surface, the inboard surface of the housing having at least one layer of reflective material.

In using the present invention, the user turns the thermoelectric module switch (not shown) to “cold” and activates the thermoelectric module 14 by plugging in the TE power cord into the AC power source 27. When a DC current is applied to the at least one thermoelectric module 14 after conversion of AC current to DC current, heat is moved from one side of the interior of the housing of the device 10 to the other sides of the interior of the housing of the device 10 to cool the air within the housing. The fan unit 16 draws in the cooled air from within the housing and then discharges the cooled air under pressure exteriorly of the housing through the hose 18. The user manipulates the hose 18 to direct the discharged cold air at the insects and other pests. In cooling the air within the housing, the at least one thermoelectric module 14 generates heat which is dissipated through the series of vents 25 in the rear of the module away from the cold air dispersal.

From the foregoing, it is to be appreciated that the device is safe and effective at substantially eliminating insects and other pests without the use of harmful chemicals. The device is easy to use and carry from one location to another.

Although a particular embodiment of the invention has been described in detail for purposes of illustration, various modifications may be made without departing from the spirit and scope of the invention. Accordingly, the invention is not to be limited, except as by the appended claims.

I claim:

1. An improved pest control device, comprising:
a housing;
at least one thermoelectric module mounted through a wall of the housing for cooling air within the housing;
a fan unit within the housing for drawing in and discharging said cooled air from within the housing; and
a hose in communication with said fan unit and extending exteriorly of the housing through which said cooled air is discharged for directing at said pests.

2. The improved pest control device of claim 1, wherein the air within the housing is cooled to an effective temperature of less than about 40 degrees Fahrenheit.

3. The improved pest control device of claim 2, wherein the air within the housing is cooled to an effective temperature of between about 0 degrees Fahrenheit and about 32 degrees Fahrenheit.

4. The improved pest control device of claim 3, wherein the air within the housing is cooled to an effective temperature of about 0 degrees Fahrenheit.

5. The improved pest control device of claim 1, wherein the housing defines at least one aperture in at least one wall of the housing through which the hose extends exteriorly therefrom and the housing further includes a front wall, a rear wall, side walls, a top and a bottom wall, and said at least one thermoelectric module is mounted through the rear wall of the housing.

6. The improved pest control device of claim 1, wherein a first section of the at least one thermoelectric module extends exteriorly of the housing and a second section extends interiorly of the housing.

7. The improved pest control device of claim 1, wherein an inboard surface of the housing includes at least one layer of reflective material.

8. A pest control device, comprising:
a housing having a front wall, a rear wall, side walls and a top and bottom wall;
at least one thermoelectric module mounted through a rear wall of the housing for cooling air within the housing to an effective temperature; and
a fan unit within the housing proximate the front wall of the housing for drawing in cooled air from within the housing and discharging said cooled air exteriorly of the housing at said pests through a hose in communication therewith which extends exteriorly of the housing through an aperture in the front wall of the housing.

9. The pest control device of claim 8, wherein a first section of the at least one thermoelectric module extends exteriorly of the housing and a second section extends interiorly of the housing.

10. The pest control device of claim 8, wherein an inboard surface of the housing includes at least one layer of reflective material.

11. The pest control device of claim 8, wherein the air within the housing is cooled to an effective temperature of less than about 40 degrees Fahrenheit.

12. The pest control device of claim 11, wherein the air within the housing is cooled to an effective temperature of between about 0 degrees Fahrenheit and about 32 degrees Fahrenheit.

13. The pest control device of claim 12, wherein the air within the housing is cooled to an effective temperature of about 0 degrees Fahrenheit.

14. An improved method for pest control comprising the steps of:
providing a housing with at least one thermoelectric module mounted through a wall of the housing for cooling air within the housing;
cooling the air within the housing by activating the thermoelectric module;
drawing the cooled air from within the housing by activating the fan unit within the housing; and
discharging the cooled air exteriorly of the housing toward insects and other pests, thereby safely and effectively substantially eliminating said insects and other pests.

15. The method of claim 14 further comprising the steps of:
applying current to each of the at least one thermoelectric module and the fan unit; and
activating the at least one thermoelectric module and the fan unit.

16. The method of claim 14 further comprising the steps of:
directing a hose at said insects and other pests, the hose in communication with said fan unit and extending exteriorly of the housing; and
discharging the cooled air exteriorly of the housing at said insects and other pests.

17. The method of claim 14 further comprising the step of: cooling the air within the housing to an effective temperature of less than about 40 degrees Fahrenheit.

18. The method of claim 17 further comprising the step of: cooling the air within the housing to an effective temperature of between about 0 degrees Fahrenheit and about 32 degrees Fahrenheit.

19. The method of claim 18 further comprising the step of: cooling the air within the housing to an effective temperature of about 0 degrees Fahrenheit.

20. The method of claim 14 further comprising the step of: providing a housing having an inboard surface, the inboard surface of the housing having at least one layer of reflective material.
